(19) United States
(12) Patent Application Publication
(10) Pub. No.: US 2023/0405520 A1
(43) Pub. Date: Dec. 21, 2023

(54) CO2 CAPTURE AND CONVERSION USING A NOVEL MEMBRANE SYSTEM

(71) Applicant: HUAZHONG MAO, Vancouver (CA)

(72) Inventor: HUAZHONG MAO, Vancouver (CA)

(21) Appl. No.: 18/205,453

(22) Filed: Jun. 2, 2023

Related U.S. Application Data
(60) Provisional application No. 63/352,367, filed on Jun. 15, 2022.

(51) Int. Cl. B01D 53/62; B01D 53/22; B01D 61/52; B01D 53/75; B01D 53/78; B01D 53/34

(52) U.S. Cl. CPC B01D 53/62; B01D 53/228; B01D 53/226; B01D 53/229; B01D 61/52; B01D 53/75; B01D 53/78; B01D 53/346; B01D 2257/504; B01D 2258/0283; B01D 2251/304; B01D 2251/604; B01D 2315/06; B01D 2311/12; B01D 2311/2603; B01D 2311/2626; B01D 2311/263; B01D 2311/2684

(57) ABSTRACT

An apparatus for capturing carbon dioxide has a membrane separator with a gas inlet, a gas outlet, a channel that extends between the gas inlet and the gas outlet, and pores configured to permit carbon dioxide to pass therethrough, the gas inlet being connected to receive a mixed gas that contains carbon dioxide, wherein carbon dioxide in the mixed gas exits the membrane via the pores, and a remainder of the mixed gas exits the membrane separator via the gas outlet. The pores may be functionalized with nano-particles. A container is filled with an aqueous solution includes a carbon capturing agent and the membrane separator is submerged within the aqueous solution. The carbon capturing agent may be produced by a membrane reactor upstream of the membrane separator. Carbon dioxide exiting the membrane separator via the functional pores reacts with the carbon capturing agent to produce a carbon negative compound.

### FIELD

This relates to a process for CO₂ capture, and in particular, a process using a membrane system.

### BACKGROUND

A change in global or regional climate patterns, in particular a change apparent from the late 20th century onwards, has been attributed largely to the increased levels of atmospheric carbon dioxide (CO₂) produced by the modern industrial activities. To reduce the levels of CO₂ in the atmosphere, many technologies have been developed in past decades for carbon capture and sequestration (CCS), including electrochemical processes.

Currently, a broad range of electrochemical processes are used in industry for inorganic as well as organic compound production. One of the issues that had to be solved on the way from the conception and development of many electrochemical processes to their industrial use was the separation of the anolyte and the catholyte in addition to the energy efficiency and the purity of the products. This was mainly motivated by the need 1) to increase selectivity, and 2) to exclude the participation of precursors or intermediate products in undesired reactions at the electrode with opposite or even the same polarity. At present, different types of porous separators (diaphragms) and semi-permeable (ion-exchange or ion-selective) membranes are developed for this purpose. In the case of membranes, selectivity has become one of the key factors of industrial electromembrane processes with the focus on a high production capacity. Another important factor on the economic feasibility of an electromembrane process is the electrical energy requirements given in kWh/ton of product. This is directly connected to the membrane characteristics, the operating voltage, the electrical charge connected with the current efficiency of the process. The operating voltage is based on the thermodynamic cell potential, overpotential of the cathodic and anodic reaction, and potential loss caused by resistance of the electrolyte and the separator (the membranes) which relates to process and energy efficiency.

Historically, homogeneous polymeric membranes represent the type first implemented in industrial practice and are probably the most widespread type of ion-selective membranes up to the present day. Since 1940, high interest in industrial applications led to the first development of synthetic ion-selective membranes on the basis of phenol-formaldehyde polycondensation, and since then the electromembrane processes have become an important segment of electrochemical technologies in the industrial applications. This is primarily due to the advantages that electromembrane processes have over competing technologies, brought about by modifications to this process that allow them to require lower energy demands, reduced impact on the environment, and making possible a higher product purity and quality.

Most of the traditional membranes act on the principle of pore dimension or selective non-electrostatic interaction of transport species with the membrane materials.

Several gas separation technologies may be used for CO₂ capturing from the various mixed gas, namely, membrane, absorption, adsorption and cryogenic. Conventional absorption technology using amine-based solvents has been in use on an industrial scale for decades, but the challenge is to recover the CO₂ complex mixed gas with a minimum energy penalty and at an acceptable cost. The traditional amine-based and many other CCS systems have been estimated to consume approximately 30% of the power plant capacity, with corresponding coal fired power generation cost increasing by 50-90%. On the other hand, many cases demonstrated that membrane-based separation methods may be employed in a energy-efficient manner than the conventional and heat-driven separations. Membrane-based separation may use up to 90% less energy than its distillation counterpart. Thus, the membrane offers great advantages as a green technology due to its lower energy consumption, no chemical solvent usage, simple operation and maintenance, and high reliability. In addition, membrane systems can be modular, hence easy for expansion and scale up, and it have a compact module design which is crucial for industrial retrofit operation.

Among membrane technologies applied in industrial applications, polymers with intrinsic microporosity (PIM) have been successfully employed in gas selective membrane. Most traditional polymeric materials have a trade-off relationship according to the Robeson plot. The more flexible the polymer chains, the higher the permeability, since the chain dynamic can affect the transport properties and the separation performance, but this is usually coupled with robustness and durability issues.

Attempts to integrate functional inorganic material to improve the selectivity and permeability of polymeric membrane gains limited success in past decade. The key issues hindering separation performance are the compatibility between the inorganic and polymeric components and the partial blockage of the sieve micropores. Recent advances related to introducing mutually interactive functional groups to the polymer and the molecular sieve have led to significant improvement on both permeability and separation performance.

### SUMMARY

According to an aspect, there is provided an integrated membrane process and system that may be used to simultaneously capture CO₂ from mixed gas and then convert CO₂ into various carbon-negative industrial chemicals. The process and integrated system make use of three engineering technologies, namely, a Selective Ion Film (SIF) membrane apparatus (SMA), a Hybrid Nano-Fibre membrane (HNF) reactor system (CCC System), and an operating system.

In some aspects, a specially engineered SMA may be used that includes sodium selective membranes with SIF technology and enhanced PTFE formula to improve the sodium ion (Na⁺) flux and selectivity. Such a SIF may possess strong hydrophobic characteristics and dense ion interactive pathways, which provide the high flux for sodium ion and minimizes the anions such as chloride from diffusing across.

In some aspects, the operating system may include a Membrane Operation (MO) unit, a Chemical Technology (CT) unit, a System Engineering and Operation (sEO) unit and an Expert AI Module (eAi), which may be linked to an Engineering Process & Operation Database such as by using 5G Tech. MO and CT modules operate the membrane systems under the designed operation conditions, while sEO and eAi modules function as engineering experts with self learning capability to continue the optimization of the system using the operation process database.

In some aspects, the CCC system may include a feed conditioner, first and second HNF selective membrane reactor systems (SMR A and SMR B), the operating system, and an off-gas recycling system. The feed conditioner is used to condition and store the CO₂ capturing agent from SMA, which may improve the efficiency, minimize the fouling of the membranes, extend the membrane life and reduce the operation cost.

In some aspects, the SMRs may include modular membrane cassettes, a membrane cleaning system, a Trans-Membrane Pressure (TMP) monitoring and operating system, a CO₂ gas analyzer and a pH/temperature analyzer. Inside the membrane cassette, the CO₂-selective HNF membranes separate CO₂ from the nitrogen dominant mixed gas. HNF technology utilizes a PVDF (polyvinylidene difluoride) formula enhanced with nano-technologies and a formulation process that forms an Asymmetric structure with intrinsic microporosity. The formula and engineering process described herein form structures of the membranes that may have improved selectivity while increasing the permeability of CO₂ gas in CO₂/N₂/O₂ gas mixture.

The CCC system may achieve a 99.9% carbon (CO₂) capture rate, while simultaneously producing carbon negative chemicals such as NaHCO₃, Na₂CO₃ etc. The CCC system may be operated in an effective temperature in the range of 5 to 50° C. and a pressure in the range of 35 to 350 kPa.

According to an aspect, there is provided a carbon capture system comprising a SIF apparatus and an operating system used to capture CO₂ from various mixed gas that may contain N₂, O₂, CH₄, H₂ in different combinations and with the CO₂ concentration varying from 5 to 70 wt % in the mixed gas. Various NaCl containing brine or sea water may be used as the raw material for manufacturing the CO₂ capturing agent. A selective ion film may be incorporated into the SIF membrane with a PTFE formula that allow for a desired level of selectivity and flux, and a suitable tolerance to concentrations of alkaline solution and chlorine gas oxidation.

According to an aspect, a SMA is provided with an electromembrane process and 3D structured surface electrodes that work with the SIF membranes to produce a CO₂ capturing agent while simultaneously producing other products, such as Cl₂, chloroacetic acid, CaCl₂, H₂, etc. The SMA may operate at a cell voltage of up to 3.8 V and a current density of up to 7000 A/m², which may be controlled and optimized by the operating system to improve current efficiency. The CO₂ capturing agent generated by the SMA may have 99.9% purity or more and may have an effective concentration in the range of 1.3 wt % to 4.2 wt %. A suitable purity and concentration may have an effect on the efficiency and life expectancy of the membrane in the CCC system.

The membrane may have an effective selectivity range of between 57 and 109 of CO₂ relative to N₂, and a flux in the range of 328 to 394 GPU in addition to high resistance to various chemicals, aging, and plasticization. The membrane may have an optimal flux around 350 GPU at the selectivity about 102 when the operation pressure is around 20 psi while the critical operation pressure ranges from 15 to 25 psi.

The operating system may include four or five modules and may communicate over a wired or wireless link (such as 5G functional link) and serves as the center of operation, optimization and remote control. The control system may be expanded as needed due to its modular structure design. The control system (OS) may be used to optimize the operation of one membrane train or any number of trains within a desired set of criteria and may be used to rotate the membrane trains to balance the membrane operation life. This allows the system to be scaled up depending on the requirements of the industrial application. The operating system may allow the remote operation and diagnosis of the process and system by experts nationally or globally.

The CCC system may use the operating system and the integrated process that may be engineered to reliably use either HNF membranes or other similar types of membranes. The CCC system may employ a compact modular engineering design of the membrane elements and membrane trains and may be engineered to have up to sixteen (16) trains. The CCC system may be engineered into different sizes and scales with an affordable and competitive industrial system. The compact modular engineering design and system flexibility may facilitate a retrofit application. With a suitably-designed membrane, the operation pressure of the CCC system may be varied from 5 to 50 PSI and the flux and selectivity may be optimized using the operating system enabling the CCC system to handle different peaking conditions while keeping the desired CO₂ capturing rate and optimal energy efficiency. Specifically, the CCC system may be sufficiently flexible to continue treatment with as little as 5% of the designed capacity, and as much as twice the designed capacity under peaking conditions.

The CCC system may be designed to capture and convert CO₂ in various gas mixtures including, but not limited to, a typical coal-fired flue gas, such as a gas stream with the following composition:
1) CO₂→8.5-12.8%,
2) N₂→76-77%
3) O₂→4.4-4.8%
4) H₂O→6.2-6.5%,
5) CO<50 ppm,
6) SO₂<420 ppm and
7) NOₓ<420 ppm.

In some examples, a CO₂ recovery rate of 99.9% may be achieved while producing about 1.9 tonne NaHCO₃/tonne CO₂ captured by the CCC system.

The two-stage design of the CCC system may be used to achieve a CO₂ recovery rate of 99.9% or more with a relatively high tolerance on the variation of CO₂ concentration of the feed gas stream, such as in the range of 5 to 70%.

The CCC system may use different raw materials, such as sea water and various types of brines such as Na₂SO₄, NaNO₃, NH₄Cl, etc. to effectively capture CO₂ from various mixed gas, and the final products can be various valuable carbon negative industrial chemicals such as, but not limited to, NaHCO₃, Na₂CO₃, (NH₄)₂CO₃, (NH₄)HCO₃, Cl₂ gas, Chloroacetic acid, CaCl₂, H₂ or liquid H₂, etc. In some examples, the brine may be based on Na, NH₄, or other components that are able to produce a carbon capturing agent. This flexibility may be enhanced using the operating system and SMA. In some examples, NaHCO₃ solutions in concentrations ranging from 50% to 99.5% saturated solution may be obtained as the final product to meet various industrial requirements. The NaHCO₃ in the saturated solution may be crystalized into solid NaHCO₃ or Na₂CO₃ products that meet the standard of membrane grade quality.

### BRIEF DESCRIPTION OF THE DRAWINGS

These and other features will become more apparent from the following description in which reference is made to the appended drawings, the drawings are for the purposes of illustration only and are not intended to be in any way limiting, wherein:

FIG. 1 is a block diagram of an integrated membrane system.

FIG. 2 is a diagram of a process that produces the CO₂ capturing agent.

FIG. 3 is a diagram of an operating system with a Membrane Operation (MO) module, a Chemical Technology (CT) module, a System Engineering and Operation (sEO) module, an Expert AI Module (eAi) and a Database cloud.

FIG. 4 is a diagram of a Carbon Capture and Conversion (CCC) system.

FIG. 5 is a molecular diagram of the key functional group structure in the polymer of intrinsic microporosity.

FIG. 6 depicts the mechanism by which the functional group enhances the membrane permselectivity and flux.

FIG. 7 is a graph that shows the CO₂ flux and CO₂/N₂ selectivity varying with CO₂ fugacity and reaches the optimal around 135 kPa (around 20PSI).

### DETAILED DESCRIPTION

There will now be described a process and integrated membrane system, identified generally by reference number 10, that captures CO₂ and converts some or all of the CO₂ into various carbon-negative industrial chemicals.

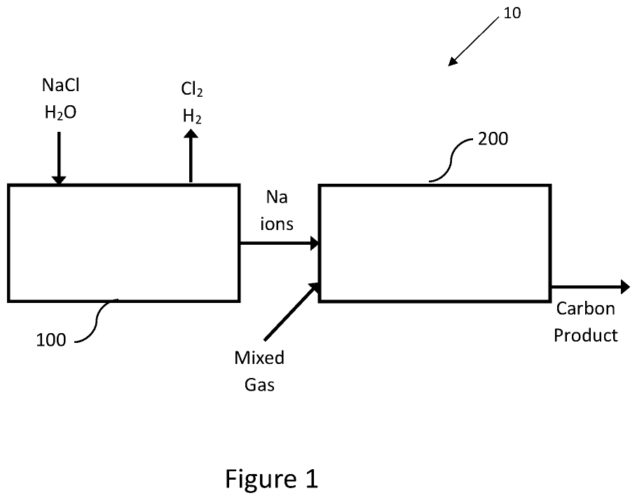

Referring to FIG. 1, the first stage of the integrated membrane system 10 is referred to as a Selective Ion Film (SIF) membrane apparatus (SMA) 100 and used to produce a CO₂ capturing agent or a precursor to the CO₂ capturing agent. In addition to producing the CO₂ capturing agent, SMA 100 may be used to produce chlorine gas (Cl₂) and hydrogen gas (H₂). Various other industrial products may also be produced, depending on the inputs, the characteristics of membrane 120, and other control variables. The second stage of the integrated membrane system 10 is a Carbon Capturing and Conversion (CCC) apparatus 200, where CO₂ is separated from a mixed gas as it passes through a submerged membrane. The CO₂ reacts with the CO₂ capturing agent in the container to produce recoverable compounds.

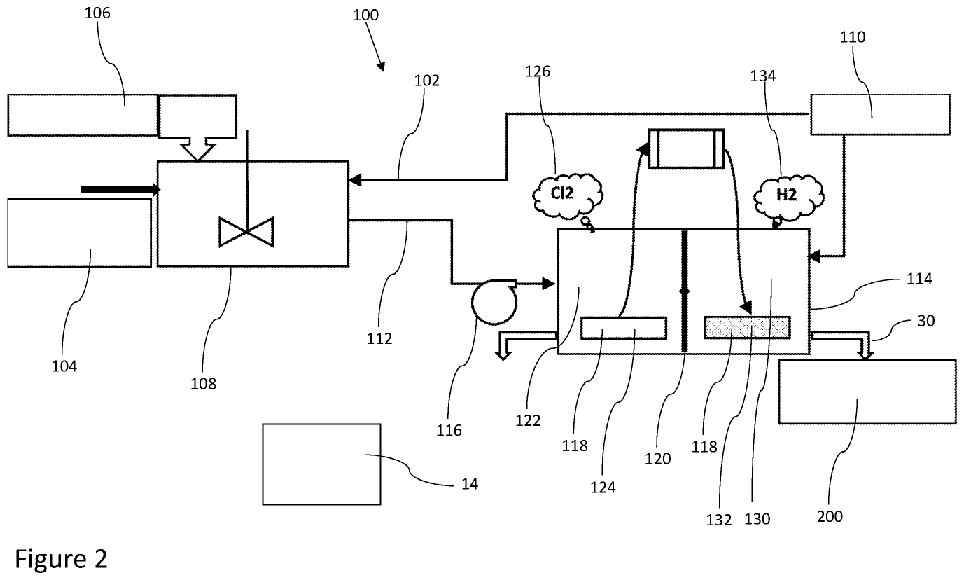

Referring to FIG. 2, in the depicted example, water 102 from a source of water 110, a source of conditioning agent 104, and a source of sodium chloride 106 are connected to a first conditioner 108 where the various components are combined at a desired ratio. Water 102 may be pure water, and the source of water may be a reverse osmosis system (RO) 110. Source of sodium chloride 106 may be a solid NaCl or various brine solutions or mixtures, which may be based on industrial-grade NaCl or other sources. Source of conditioning agent 104 may be a caustic agent, for example, NaOH, Na₂CO₃, etc., or combinations thereof. Other additives may be included to improve efficiencies, and/or the life of the membrane, etc. The amount of water 102 added will be based on the desired concentration(s) of sodium chloride and/or caustic from sources 106 and 104, respectively. For example, the concentration of NaCl may be about 26 wt % NaCl (about 180-240 g/dm³ NaCl) with a pH of 1.0 to 4.5.

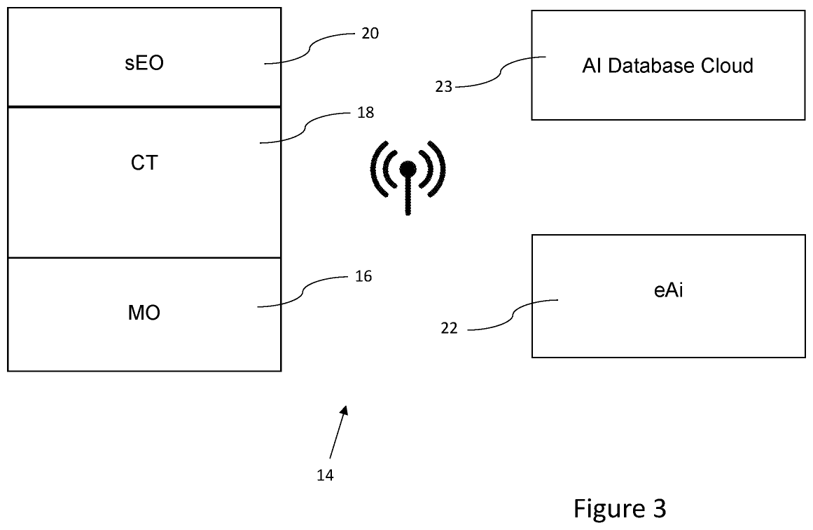

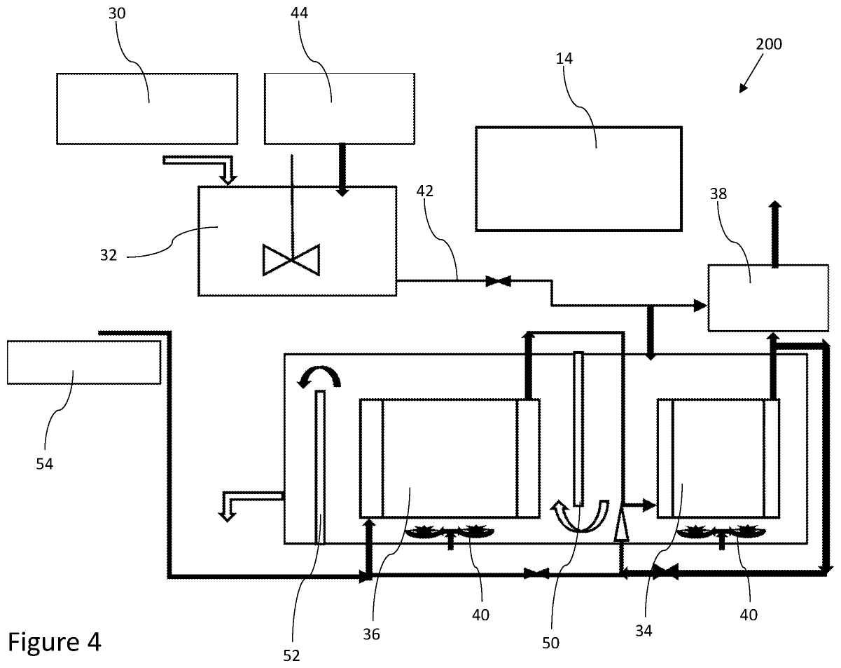

As noted above, the components are mixed together in first conditioner 108 to form a conditioned feed solution 112. The mixing time may be about 1 to 3 minutes of continuous mixing prior to adding conditioned feed solution 112 into an SMA tank 114 or other suitable container using a pump 116. When an appropriate current is applied to electrodes 118, sodium and hydrogen pass through a membrane 120 in SMA tank 114, while chlorine and other components do not. A capturing agent or capturing agent precursor 30 is produced for use in Carbon Capture and Conversion (CCC) System 200 depicted in FIG. 4, and may include sodium ions, hydroxyls, compounds that include sodium and hydroxyl, or other ions, molecules, compounds, etc. The composition of capturing agent 30 may be controlled by the operating system 14 (shown in FIG. 3) and by modifying the operating parameters of the first stage.

SMA system 100 may include a system of asymmetric SIF membranes and electrodes that is controlled with the operating system 14. As SIF membranes may be relatively thin and fragile, they may be reinforced with polytetrafluoroethylene (PTFE) to increase their mechanical strength for wide industrial applications. In a traditional electromembrane process, the voltage efficiency of the process is mainly caused by activation overpotential of the anode reaction and ohmic drop on the membrane. Using such an SIF membrane, the current efficiency loss mainly accounts for the transport of hydroxyl ions from the cathode to the anode compartment due to joint diffusion and migration. When enhanced with PTFE, the SIF technologies may form a strong ion charged surface film on top of the PTFE, thus reducing the flow of hydroxyl and chloride ions, improving the energy efficiency while producing a CO₂ capturing agent with relatively high purity.

The SIF membranes with dense ion surface may be used to provide a selective pathway for sodium (Na⁺) ions, minimize anions such as chloride (CI⁻) or other anions from diffusing across SIF and decrease in hydroxyl ion flow back to the anode inside the cathode chamber, and decrease the membrane resistivity; in other words, the SIF membrane may be designed to keep the OH⁻ and Cl⁻ ions away from the membrane surface to reduce the potential polarization on the SIF surface, and enhance the flux of sodium (Na⁺) ion selectivity that increases the purity and concentration of the capturing agent in an energy-efficient manner.

The conditioned solution from conditioner 108 is then fed into an anode chamber 122 inside the SMA tank 114. To avoid concentration polarization around an anode 124, conditioned solution 112 may be uniformly distributed around anode 124 in anode chamber 122. The ionic contact between the SIF membrane 120 and the electrode results in the formation of a three-dimensional active layer, providing a contacting surface and ionically conductive pathways among the electrodes 118, SIF membrane 120 and the electrolyte. This may improve the electric efficiency and life of anode 124.

Depending on the requirements and operation from the down stream process, the voltage applied to electrodes 118 may vary, such as from 1.5V to 3.8V, and which may be continuously optimized with an operating system 14 during the operations. As a result, the Cl⁻ ion in anode chamber 122 is converted into Cl₂ gas 126 and collected from the top of Anode chamber 122. The quality of chlorine gas 126 may be sufficient to be liquified as liquid chlorine product. If desired, chlorine gas 126 may also be converted into various carbon negative chemicals, such as hypochloric acid, chloroacetic acid, or dissolved into a CaO solution to form CaCl₂. Any residue from anode chamber 122 may be continuously removed and properly disposed of. Carbon negative compounds (or chemicals) include those compounds that are produced from carbon dioxide and stable under normal temperature and pressure conditions.

A cathode compartment 130 inside SMA container 114 may be initially fed with a 0.1% wt water solution of sodium hydroxide, with a pH of about 14. Under the applied voltage, the water solution is initially reduced to gaseous hydrogen and hydroxyl ions simultaneously at a cathode 132:

2H₂O+2e⁻=H₂2OH⁻E^{O}_{(H2O/H2)}=−0.828 V

Hydrogen gas 134 generated in the Cathode chamber 130 may be collected from the top of cathode chamber 130, then compressed or liquified for industrial use. In some examples, the purity of hydrogen gas 134 may exceed 99.95%.

With the applied voltage, the Na⁺ ion in anode chamber 122 is pulled to SIF membrane 120, driven through SIF membrane 120 and into cathode chamber 130, where the Na⁺ ion is reacted with OH⁻ ions in the conditioned agent to form CO₂ capturing agent 30. An optimum concentration of capturing agent 30 in cathode chamber 103 may be controlled by operating system 14, depending on the requirements from the CCC system 200 operation. Inside SMA tank 114, an appropriate design of SIF 120 helps produce a high quality of CO₂ capturing agent 30 in an energy efficient manner.

FIG. 3 shows an example of an operating system 14. Operating system 14 is used to control the operation of membrane system 10, or components thereof. Operating system 14 may be computerized, and may be implemented on a general-purpose computer, a purpose-built computer, or separate modules, each of which may be computerized, and may be general-purpose or purpose-built. If implemented in separate modules, each module may be configured for independent operation, or based on feedback or control signals from other modules. Operating system 14 and the modules (if present) may communicate with the membrane system, sensors on the membrane system, user interfaces, and other modules via hardwired connections or wireless connections. Each module may be programmed based on well-known algorithms, basic I/O programming, or may be programmed using artificial intelligence (AI), which may include machine learning. In the example shown in FIG. 3, the operating system 14 may include the following modules: a Membrane Operation (MO) unit 16, a Chemical Technology (CT) module 18, a system Engineering and Operation (sEO) module 20, an Expert AI (eAi) Module 22, and a database cloud 23. MO and CT modules 16 and 18 operate the membrane systems under the designed operation conditions, while sEO and eAi modules 20 and 22 function as engineering experts to continue fine tuning the systems according to the engineering models and operation process database. Furthermore, the CT, sEO and eAi modules 18, 20, and 22 may control the SMA based on feedback from raw feeding material and conditions of the raw feeding gas as well as the designed CO₂ recovery from the CCC system.

The sEO and eAi systems 20 and 22 may also enable the SMA 100 and the CCC system 200 to be operated remotely, which may allow the operator to remotely diagnose the system problems and fine tune the operation to improve the operation efficiency and reliability.

FIG. 3 illustrates an example in which operating system 14 is used to control, monitor and optimize SMA system 100 operation depending on the overall operation requirements from the CCC system 200. The final concentration of the solution inside SMA system 100 may be controlled in the range of 3-9% (wt %) that may serve as CO₂ capturing agent in CCC system 200. The capturing agent may then be collected and stored for use in Carbon Capturing and Conversion (CCC) System 200.

With the optimization from operating system 14, the energy efficiency of SMA system 100 may be improved relative to electrolysis with a conventional process such as a porous diaphragm. Safety improvement in SMA system 100 represents an additional important aspect.

FIG. 4 depicts an example of CO₂ capturing and conversion process and integrated two-stage CCC system 200. CCC system 200 includes a feed conditioner 32 and first and second selective membrane reactor SMR systems 34 and 36, each of which may be controlled by operating system 14. CCC system 200 may be provided with an off-gas recycling system 38 and a membrane maintenance and recovery cleaning system 40. The conditioned capturing agent 42 from feed conditioner 32 is directly fed into first SMR 34 while CO₂ mixed gas 54 flows through the internal channels of the membranes of SMRs 34 and 36.

In the depicted example, CO₂ capturing agent 30 from first stage 12 is conditioned with a second conditioning agent 44 in feed conditioner 32, and then fed into first SMR 34, while the mixed CO₂ gas from second SMR 36 with the lowered CO₂ concentration flows through the membrane in first SMR 34 along the membrane's internal channel (not shown). Second conditioning agent 44 may be based on sodium and hydroxide ions or related compounds obtained from SMA 100. Second conditioning agent 44 may also include other additives that improve stability, improve efficiency, or improve the life expectancy of the membrane. In some examples, NaHCO₃ may be included as a seeding compound. Water may be added as needed. While the number of reactors may vary, the depicted example includes first and second SMRs 34 and 36 separated by a baffle 50, and a weir 52 adjacent to the outlet of second SMR 36. Baffle 50 and weir 52 may be provided to control the fluid flow and therefore the reaction as the mixed capturing agent from first SMR 34 flows into second SMR 36 at the bottom by the gravity. As the CO₂ exits membrane 46, it reacts with the capturing agent to produce a recoverable compound, such as NaHCO₃. The membrane maintenance and recovery cleaning systems 40 may be automatically operated and controlled by the operating system. The number of SMR stages may be increased or decreased, depending on the materials available and the desired results. It will also be recognized that, if an alternative carbon capturing agent is obtained, CCC system 200 may be operated without SMA 100.

Depending on the overall operation, the concentration of CO₂ in the mixed gas from second SMR B may vary from 1 to 18.5%. In case of the flue gas from a power plant, an example of a typical composition of the raw flue gas may be as follows:
1) CO₂→8.5-13.8%,
2) N₂→76-77%
3) O₂→4.4-4.8%
4) H₂O→6.2-6.5%,
5) CO<50 ppm,
6) SO₂<420 ppm and
7) NOₓ<420 ppm.

With the CO₂ concentration varying from 8.5% to 13.8% in the raw mixed gas, the feeding CO₂ concentration to SMR A may vary from 3.1 to 6.9% and the recovery rate may be greater than 99.9%. this may be achieved through optimization of the operating parameters, and/or by recycling the mixed gas, such as from first SMR 34 back to second SMR 36.

When the CO₂ mixed gas flows through the internal channel of the membranes of SMRs 34 and 36, the CO₂ is selectively permeated through the membranes from the inside to the outside surface of the membranes. The CO₂ at the surface of the membranes reacts rapidly with the high concentration of the fresh CO₂ capturing agent. The large reacting surface provided by the membranes and fast chemical reactions may allow the capturing agent to capture more than 99.9% CO₂ permeated through the membrane. Under the control of the operating system 14 (as shown in FIG. 3), the membrane surface may be intermittently cleaned and the thin liquid film of the capturing agent on the surface may be continuously renewed using an integrated membrane maintenance cleaning process. Thus, the free CO₂ concentration at the membrane surface may be virtually close to zero to ensure high recovery rate, and the CO₂ in the mixed gas inside the membrane channel may continue to permeate through the membrane with a maximum concentration gradient that ensures the maximum and constant flux. The CO₂ concentration may be monitored and controlled at less than 0.1% in the off-gas, which may allow more than 99.9% of the CO₂ in the mixed gas to be recovered and converted into carbon negative industrial chemicals that is well dissolved in the CO₂ capturing agent. If desired to meet a higher removal rate, for example, up to or higher than 99.9%, the off gas from the exit of the membrane inside first SMR 34 may be recycled back at the designed ratio effectively controlled by operating system 14. The mixed gas flow rate and pressure may also be controlled by the designed removal rate of the CO₂ in the mixed. The feeding rate and concentration of capturing agent 30 may also be controlled using operating system 14 based on the concentration of the desired product.

The partially-used CO₂ capturing agent 30 from first SMR 34 flows into second SMR 36 at the bottom by the gravity and continues to capture CO₂ at the surface of the membranes inside second SMR 36 while the raw CO₂ mixed gas such as the flue gas from the power plant flows through the membranes from second SMR 36 to first SMR 34.

SMR uses HNF membranes, which are hybrid nano-fibre membranes containing specially engineered nano-particles and employing an asymmetric structure formed with an advanced polymeric formula. Compared to many traditional polymeric membranes, the specially engineered nano-particles, the enhanced compatible polymeric formula, and advanced engineering process allows novel structures to be formed that have better selectivity and increased permeability for CO₂ in a CO₂/N₂/O₂ gas mixture, while maintaining the advantages of mechanical stability of PVDF polymeric membranes and the possibility of large-scale production.

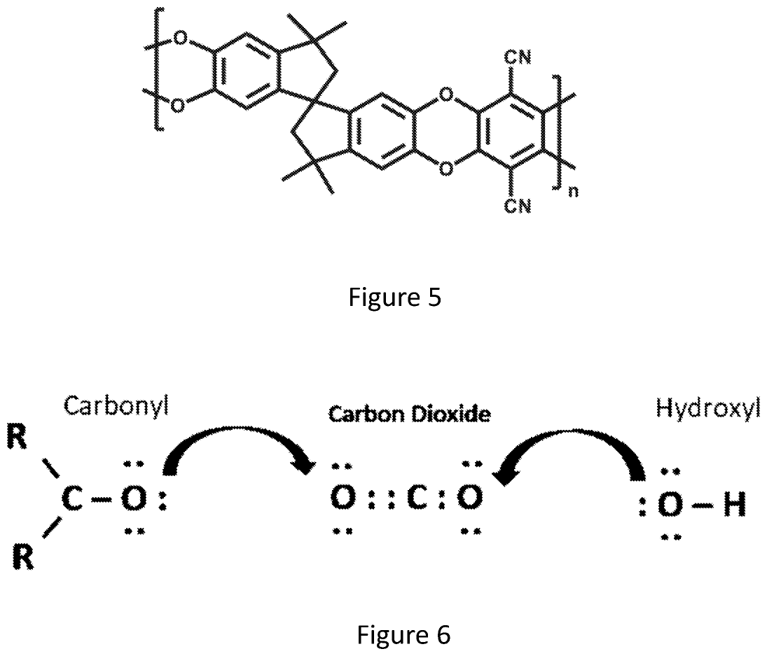

Depending on the composition of the raw mixed gas and operation conditions, the ratio of membranes in second SMR 36 to that in first SMR 34 may be engineered to vary from 0.8 to 3.8 based on final process requirements. The membranes in SMRs 34 and 36 may be functionalized to enhance the separation of CO₂ from the mixed gas using the nano-particles with specific functional groups, such as the functional groups shown in FIG. 5. The specially engineered nano-particles may be embedded in the polymeric matrix employing the asymmetric structure formed with the advanced polymeric formula, together forming integrated functional pores at inner layer of the membranes.

The selective membrane reactors 34 and 36 in CCC system 200 may contain membrane modules, cassettes with 24 to 64 modules, any may be connected to, or include, online analyzing and monitoring systems, and integrated maintenance and recovery systems 40 that may be controlled and operated by the operating system 14. The membrane cassettes (not shown) may be designed as a basic modular element, and engineered into an independent train. In some examples, between 2 and 16 independent trains may be used in CCC system 200 depending on the mass flow of a CO₂ mixed gas. Therefore, the modular engineering design may be easily applied for various industrial scales. Furthermore, using a modular engineering design and the operating system, CCC system 200 allows rapid startup and each train may be easily isolated from the system for troubleshooting and repairing. In some examples, CCC system 200 engineering may allow various membranes besides the HNF membranes to be utilized for CO₂ capturing and conversion.

The membranes used in SMRs 34 and 36 may be manufactured with an enhanced thick PVDF layer that support the strength and rigidity of the membrane. Nano particles may be embedded into the matrix with the intrinsic micropores forming a flexible polymeric structure that may be regulated with operational pressure and other operational parameters. The pores of the membrane may also be referred to as void volumes, and may be functionalized with nano-particles. This approach may be used to increase the amount of the free volume in the membrane matrix. As a result, the CO₂ gas flux is increased and may be regulated according to the operation and feeding mass flow of CO₂ mixed gas.

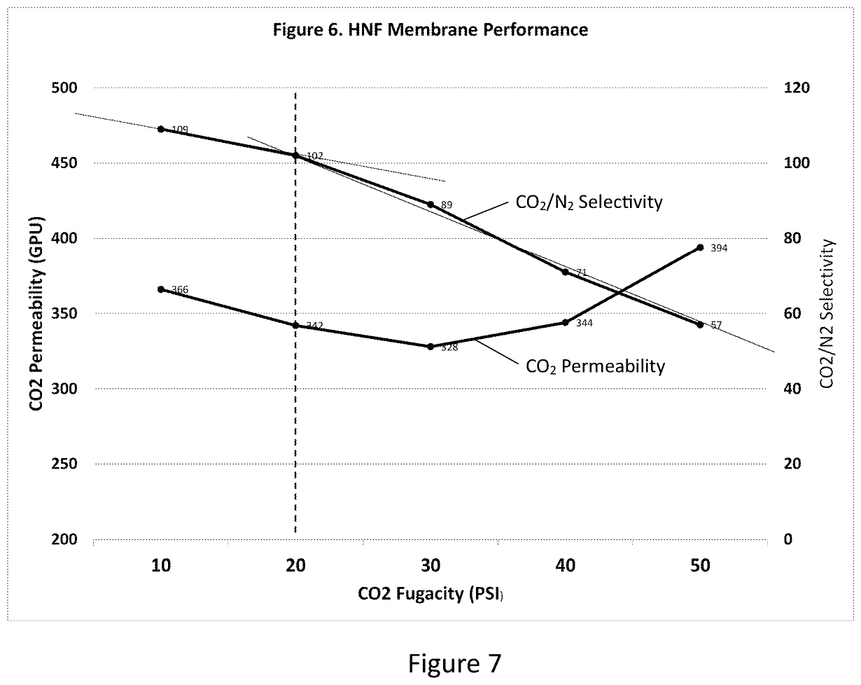

FIGS. 5 and 6 illustrate the thin layer formed with the selective functional groups that significantly enhance the selectivity. By replacing some pendent groups in the polymeric matrix, the integrated Carboxylic and Hydroxyl groups structures in the thin layer may substantially improve the CO₂ selectivity.

As shown in FIG. 7, when CO₂ fugacity varies from 5 to 50 PSI, the permeability and selectivity of the membrane system vary significantly. FIG. 7 demonstrated that 1) the membrane can reliably operate under relatively low pressure ranging from 5 to 50 PSI, 2) the optimal pressure ranges from 10 to 20 PSI in which the flux and selectivity are optimized, 3) when the operation pressure is over 20 psi, the flux increases by more than 20% but the selectivity decreased by 15 to 50%. This indicated that the microporous structures are affected significantly when it is over the critical range. On the other hand, this feature may be used for improving the productivity while the CO₂ recovery is not controlling factor. Thus, the system is more reliable and flexible in balancing operation performance and productivity.

The two-stages of CCC system 200 discussed herein may be used to effectively capture CO₂ from various gas mixtures that may then be converted into carbon negative chemicals for various industrial applications. CCC system 200 may include one or more of the following aspects.
A. With the advanced PVDF formula, HNF membranes may be used that have high strength, strong resistance to various chemicals, aging and plasticization as well as being easily and economically manufactured into different sizes and shapes of membrane modules.
B. The operating system 14 may be configured into five modular blocks that communicate using a wireless link, such as by 5G, where each block may be operated independently or with other modules depending on the process requirements. The operating system 14 may be expanded with more modular blocks depending on the process and operation requirements.
C. The HNF membrane may be designed to operate with optimal flux and selectivity when the operation pressure is within the pressure range of 15 to 25 psi. When the pressure is over the critical range, the flux may increase, such as by more than 20%, at the price of decreasing selectivity. This feature allows the membrane system to manage the peaking conditions when the CO₂ capturing rate is allowed to vary or an emergency repair is required while keeping continuous operation. On the other hand, when at low demand, CCC system 200 with the modular engineering design may also be operated with the minimum amount of the membranes while the rest of CCC system 200 may be properly maintained and reserved to save the energy and operation cost, as well as extend the membrane life. In other words, combining operating system 14 with the modular engineering design allows CCC system 200 to operate at the higher (up to 200%) designed capacity or at lower (down to 5 or 10%) design capacity when desired.
D. The operating system 14 may be programmed to control the process operational parameters, such as the pressure, membrane flux, pH and other parameters, to improve the process operation including the productivity and quality of the final products. For example, the operational pressure and/or temperature may be controlled to manage the flux, permselectivity, and energy efficiency. Depending on the composition of the mixed gas and desired final chemicals, the MO module may be used to improve the operation pressure within the range of 5 to 50 psi. Moreover, The MO and CT modules in the operating system can also carry out automatic maintenance and recovery cleaning of the membrane systems, thus, it improves the productivity while maintaining the membrane performance and to minimize membrane fouling and extend the membrane operation life.
E. The operating system 14 may allow for the remote control and diagnoses of the process operation so that operation issues may be resolved by experts, remotely if needed. This may result in an improved or optimized start-up, and enhance troubleshooting capabilities.
F. CCC system 200 may employ a modular membrane design. The modular design allows the system to scale up, such as up to 16 trains for various industrial applications.
G. CCC system 200 may be engineered to operate in a relatively low-pressure range. The low operation pressure may reduce energy consumption and may improve reliability and safety. Furthermore, by producing valuable carbon negative chemicals, CCC system 200 can be profitable for capturing CO₂ from various CO₂ gas mixture.
H. By properly managing a high flux and peaking factor using the operating system, CCC system 200 may be designed with reduced membrane area requirements, which may also reduce the capital cost. This may make CCC system 200 more practical and economical for large scale industrial application.
I. Using a two-stage engineering design, CCC system 200 may have an improved energy efficiency, reliability and flexibility, and in some examples, may be used to achieve a CO₂ capturing rate of better than 99.9%. Operating system 14 may be used to improve the tolerance of CCC system 200 to variations of CO₂ concentration in the feeding mixed gas. In some examples, operating system 14 may accommodate variations in CO₂ concentrations from 5 to 70%.
J. With operating system 14 and SMA system 100, CCC system 200 may use different raw materials such as sea water and other form of brines, and the final products may be various valuable carbon negative industrial chemicals such as NaHCO₃, Na₂CO₃, Cl₂ gas, chloroacetic acid, CaCl₂, liquid H₂ etc. For example, various concentrations of NaHCO₃ solution ranging from 50% to 99.5% saturated solution may be obtained as the final products to meet various industrial requirements. If desired, the NaHCO₃ in the saturated solution may be simply crystalized into solid NaHCO₃ or Na₂CO₃ products that meet the standard of membrane grade of NaHCO₃/Na₂CO₃.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context requires that there be one and only one of the elements.

The scope of the following claims should not be limited by the preferred embodiments set forth in the examples above and in the drawings but should be given the broadest interpretation consistent with the description as a whole.

What is claimed is:

1. An apparatus for capturing carbon dioxide, comprising:
A membrane separator having a gas inlet, a gas outlet, a channel that extends between the gas inlet and the gas outlet, and pores configured to permit carbon dioxide to pass therethrough, the gas inlet being connected to receive a mixed gas that contains carbon dioxide, wherein carbon dioxide in the mixed gas exits the membrane via the pores, and a remainder of the mixed gas exits the membrane separator via the gas outlet; and
a container filled with an aqueous solution that comprises a carbon capturing agent, the membrane separator is submerged within the aqueous solution, wherein carbon dioxide exiting the membrane separator via the functional pores reacts with the carbon capturing agent to produce a carbon negative compound.

2. The apparatus of claim 1, wherein the pores comprise nanoparticles that functionalize the pores.

3. The apparatus of claim 1, wherein the carbon capturing agent comprises sodium ions, hydroxide ions, sodium compounds, hydroxide compounds, or combinations thereof.

4. The apparatus of claim 1, wherein the container comprises first and second compartments separated by a baffle, wherein the membrane separator is submerged in the first compartment and a second membrane separator is submerged in the second compartment, wherein an outlet of the second separator being connected to the inlet of the membrane separator.

5. The apparatus of claim 1, wherein the carbon dioxide comprises between 5 and 70 wt % of the mixed gas, the mixed gas further comprising one or more of: nitrogen, oxygen, methane, and hydrogen.

6. The apparatus of claim 1, further comprising a primary membrane separator positioned within a primary container, the primary membrane separator defining a first volume and a second volume within the primary container, the primary membrane separator having pores configured to permit sodium and hydrogen to pass therethrough, the first volume receiving a mixture of sodium chloride, water, and a caustic agent, wherein an applied potential voltage causes sodium and hydrogen to pass through the primary membrane separator, the primary container having an outlet in fluid communication with the container.

7. The apparatus of claim 6, wherein the pores of the primary membrane separator comprise nanoparticles that functionalize the pores.

8. The apparatus of claim 6, wherein the container comprises a preconditioner that receives sodium from the outlet of the primary container, the sodium being conditioned in the preconditioner to form the carbon capturing agent prior to being transferred to the container.

9. The apparatus of claim 6, wherein chlorine gas exits the first volume of the primary container, and hydrogen gas exists the second volume of the primary container.

10. The apparatus of claim 9, wherein the primary container further produces chloroacetic acid, CaCl₂, or both chloroacetic acid and CaCl₂.

11. The apparatus of claim 6, wherein the applied voltage comprises a cell voltage of 3.8 V or less and a current density of 7000 A/m² or less.

12. The apparatus of claim 1, wherein the carbon capturing agent reacts with the carbon dioxide to produce at least one of: NaHCO₃, Na₂CO₃, (NH₄)₂CO₃, and (NH₄)HCO₃.

13. The apparatus of claim 1, wherein the membrane comprises a PTFE-based material.

14. The apparatus of claim 1, wherein the membrane separator has an effective selectivity of between 57 and 109, and a flux in the range of between 328 and 394 GPU.

15. The apparatus of claim 1, wherein a pressure of the mixed gas in the membrane separator is between 15 and 25 psi.

16. The apparatus of claim 1, further comprising an operating system that is programmed to control an operation of the membrane separator.

17. The apparatus of claim 16, wherein the operating system comprises a wireless communication link.

18. The apparatus of claim 16, wherein the operating system comprises a plurality of control modules.

19. The apparatus of claim 1, wherein the membrane separator comprises a plurality of membrane modules.
